(19) United States
(12) Patent Application Publication
(10) Pub. No.: US 2004/0045903 A1
(43) Pub. Date: Mar. 11, 2004

(54) Apparatus and methods for recycling biological waste

(75) Inventor: Rexford Charles Johnson, West Linn, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Creative Waste Solutions, Inc., West Linn, OR

(21) Appl. No.: 10/237,446

(22) Filed: Sep. 6, 2002

(51) Int. Cl. B01D 37/00; B01D 35/00; B01D 39/00

(52) U.S. Cl. 210/649; 210/283; 210/435; 210/456; 210/503

(57) ABSTRACT

The invention relates to methods of treating contaminated fluids especially formalin. The device being able to pass a large volume of solid, lipid and cell contaminated material through it and being stable from shipping problems.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

This invention relates to a chamber (filter containment system) for use in a gravity-fed Formalin Recycling System. In particular, this invention relates to a containment system having a novel and new approach to recycling waste formalin that contains biological material such as lipids and membraneous material that tend to clog up other filtration systems. The system is an improvement over other methods that use mechanical devices and heating of such said material.

Formalin is used in histology/pathology labs in the Life Sciences Field such as in hospital, reference labs, clinics, research labs, government facilities and companies. Formalin is used in the preserving process to preserve and process tissues for histological procedures and other procedures as well.

For many years such facilities mentioned above have been handling and or disposing of this waste formalin after use in three basic ways: first they may have simply dumped this waste down the drain. This may or may not have been legal as many POTW's (Publicly Owned Treatment Waterworks) are starting to disallow such practices as this waste stream is becoming a problem for them. Secondly, such facilities have been paying to have this formalin waste hauled away which can be very expensive. Third, they can recycle their formalin waste by the use of distilling apparatuses. This distillation process is very expensive, time consuming and can be dangerous. Expensive because you have to purchase the equipment and maintain it. One must purchase continually the buffered salts as these salts come out of solution from this process. Dangerous, as the heating process can produce formaldehyde fumes and fires. Recently, another way to treat formalin waste has come to the market. That via neutralizing this waste formalin. This method of neutralizing the waste formalin is very expensive and can be time consuming as well. Clearly another more safe, user friendly, easier, novel, new and unique way to recycle the waste formalin that will save time and money to the laboratories is long over do.

The present invention relates to the issues and problems mentioned above. Generally, recycling comprises taking a particle contained fluid and processing it to remove the particles from the dirty fluid so that it can be reused. As mentioned above the only way to recycle this formalin waste is via the distillation process. As mentioned above it has many drawbacks especially the danger, costs, time and the loss of buffered salts when using neutral buffered formalin. The present invention is directed to an apparatus and method for the recycling of formalin containing particles without the use of electricity, heating or the loss of the neutral buffered salts all while saving time, money, increasing safety all while helping and benefiting the environment.

### BRIEF SUMMARY OF THE INVENTION

This invention provides for a filter cartridge for treating aqueous fluids containing fats and lipid membranes, the cartridge comprising an inlet, an outlet, a cartridge housing and filtration material where: the cartridge housing comprises a side wall connected to a bottom end wall and an end wall with the walls forming a cartridge defining an inside portion; the inlet is positioned proximal to or adjoining the upper end wall and the outlet is positioned proximal to or adjoining the bottom end wall; the inside portion contains a top fluid diffuser, bottom fluid diffuser and filtration material wherein: the top fluid diffuser is a multi-perforated wall laterally positioned with regard to the flow of the aqueous fluids and residing below the inlet and above the bottom fluid diffuser; the bottom fluid diffuser is a multi-perforated wall positioned above the outlet, having a greater solid surface area than open surface area and capable of preventing the filtering material from passing through the outlet; and the filtration material comprises fibrous and particulate filtering components where the fibrous filtering component is positioned between the inlet and the top fluid diffuser and above the bottom diffuser and below the particulate filtering component and where the particulate filtering component is positioned between the bottom fluid diffuser and top fluid diffuser.

The filter cartridge may hae a removable top. The outlet is optionally positioned on the end wall or on the side wall. The particulate component of the filtration material is preferably charcoal. The fibrous filtering component is selected from the group consisting of: cotton, glass wool, and polytetrafluroethylene. The filter cartridge can be either a cylinder or of a polygon form. The fluids being treated may contain formalin. The inlet can be optionally in the form of a funnel. The top fluid diffuser can be removeable.

The invention further provides for a method for purifying contaminated aqueous fluids comprising the step of passing fluid through a filter cartridge comprising an inlet, an outlet, a cartridge housing and filtration material where: the cartridge housing comprises a side wall connected to a top end wall and an bottom end wall with the walls forming a cartridge defining an inside portion; the inlet is positioned proximal to or adjoining the bottom end wall and the outlet is positioned proximal to or adjoining the top end wall; the inside portion contains a top fluid diffuser, a bottom fluid diffuser and filtration material wherein: the top fluid diffuser is a multi-perforated wall laterally positioned with regard to the flow of the aqueous fluids and residing below the inlet and above the bottom fluid diffuser; the bottom fluid diffuser is a multi-perforated wall positioned above the outlet, having a greater solid surface area than open surface area and capable of preventing the filtering material from passing through the outlet; and the filtration material comprises fibrous and particulate filtering components where the fibrous filtering component is positioned between the inlet and the top fluid diffuser and above the bottom diffuser and below the particulate filtering component and where the particulate filtering component is positioned between the bottom fluid diffuser and top fluid diffuser. The alternative embodiments are as provided above.

### BRIEF DESCRIPTION OF THE DRAWINGS

FIG. 1 is a cross section of or a transverse section (internal side view as you sent me)

### DETAILED DESCRIPTION OF THE INVENTION

I. Definitions

Fats—A oily greasy, soft-solid material, found in animal tissues and many plants, composed of a mixture of glycerides; together with oils these make up that class of foodstuffs known as simple lipids.

Lipid membranes—Fat; “fat soluble covering” substances extracted from animal or vegetable cells by nonpolar or fat solvents (alcohols, ether, chloroform, formalin, benzene, etc.).

Anatomical Pathological debris—Any and all parts of the animal or plant ranging from the cellular, tissue and organ level.

Stains and Dies—Liquids and or solid material that stain the inside or outside of cells or tissue matter.

II. The Cartridge

The present invention provides a for a cartridge for recycling aqueous fluids contaminated with lipids, cellular debris and other biological impurities. The device is used for the recycling of dirty formalin and or other liquids without the use of distillation apparatus. The device requires no electricity run entirely on gravity and does not heat the liquids that are being filtered through it. Purifying used formalin fluids is a preferred application for the invention.

The cartridge is an especially safe easy way to recycle formalin and other liquids giving you back the same volume of liquid and concentration of liquid you put through it. This is an new and unique method with respect to recycling neutral buffered formalin as the buffered salts are allowed to pass through the device along with the cleaned up formalin into a clean receptacle ready to be used again.

The cartridge comprises a chamber or housing that can be made out of plastic, metal and or any other material that is compatible with the solution being recycled through the device. The chamber or housing has a top and a bottom. The top is optionally removable and can be of any size. The bottom is preferably domed with the ability to have an outlet line securely attached to it so that liquid can exit at the bottom or close to it. The outlet is preferably at the bottom of the cartridge but could be place proximal to the bottom and positioned laterally to the axis of the side wall of the cartridge.

The outlet bottom of the chamber or housing is valved. This valve can be of any conventional type of on/off type valve including butterfly, stopcock or gate valves. The valve should be capable of completely shutting off thus stopping the flow of liquid out of the bottom portion if the chamber at any time. This valve can regulate flows of between 1 ml. to 10 gallons per hour. Preferably the valves are a two-way ball valve sustaining pressures of between 1 to 125 PSI or more. The valves can be straight or angled. The end connector (or inlet) of the valve can be between 1/16 of an inch or larger, the inlet of the valve should be barbed to allow tubing to be best secured to it. The outlet end of the valve should be threaded to allow a shut off male or female quick connect screwed into it. The quick connect can be either a shut off or opened ended quick connect.

The internal components of the cartridge include the top and bottom fluid diffusers, with filtration material sandwiched between the diffusers. The filtration material comprises a fiberous filtering component and a particulate filtering material.

The top and bottom diffusers can be made of plastic, metal, aluminum or any other ridged component that is strong enough to hold the pressure of the slurry and fluid it is to hold either when operating or while the system is being transported. The diffusers thickness is not critical but is preferably between 1/16″ to 1″ or thick. The diffusers are perforated evenly with holes. This allows for the even transfer or flow of formalin to be recycled to through the slurry. The holes in the diffuser material could be between 1/32″ to ½″ in diameter or larger or smaller evenly placed 1/16″ to ½″ apart either closer or father as well.

The fiberous component is located on the top of the slurry and underneath the top diffuser and on top of the lower diffuser and underneath the lower level of the particulate component. The fiberous component could be made of natural or man made material. Such material includes but is not limited to cotton, polyester fiber, glass wool, polytetrafluroethylene (PTFE) which Dupont named Teflon®, cloth or other material that will not allow the particulate component (slurry) to come through the diffuser at the bottom of the chamber and exiting the system. This material must also allow for the continuous flow of liquid to pass through it at all times while the system is operating and be compacted sufficiently to hold the slurry in place while the system is operating and being transported.

The particulate filtering component or slurry material used in the device can vary greatly depending how long one wants the system to last and work. Any material that could adsorb and filter fats, lipids, stains, dies and cellular debris may be suitable. Charcoal could be used. The particle size of the charcoal that could be used could range from 50 to 200-mesh size. One could use smaller and or larger size particles as well. In addition to charcoal, diatomaceous earth could also be used either alone or in combination. Ionically charged resin beads could also be used.

When assemblying the cartridge it is useful to wet the slurry completely with water by stirring water in the slurry making it into a paste like substance for it to be poured into the chamber.

Once the slurry is ready to pour into the housing to make the cartridge it should be assembled as follows. One diffuser should be placed at the bottom of the exit port of the chamber. The fiber material shall go on top of the bottom diffuser material. The fiber material should go on top of the diffuser wet as this allows for the fiber material to be packed in the correct fashion not allowing the slurry to come out the bottom of the chamber.

The slurry material is then poured on top of the lower filter material. It is important to pack the slurry material firmly for best results. This is accomplished by one of two ways, vibrating the slurry in place by hand or by mechanical means. Standing water on and in the slurry should be allowed to drain out of the chamber.

Fiber material is then placed on top of the slurry and the upper diffuser is set into place on top of the fiber material.

Use of the device could include but not be limited to the recycling of formalin, alcohol or any other liquid one would want to remove particles from whether biological or not.

The invention allows for the passage of dirty formalin through the top of the Formalin Recycling System exiting out the bottom draining into the recycled formalin receptacle giving the operator clean recycled formalin to be used over and over again.

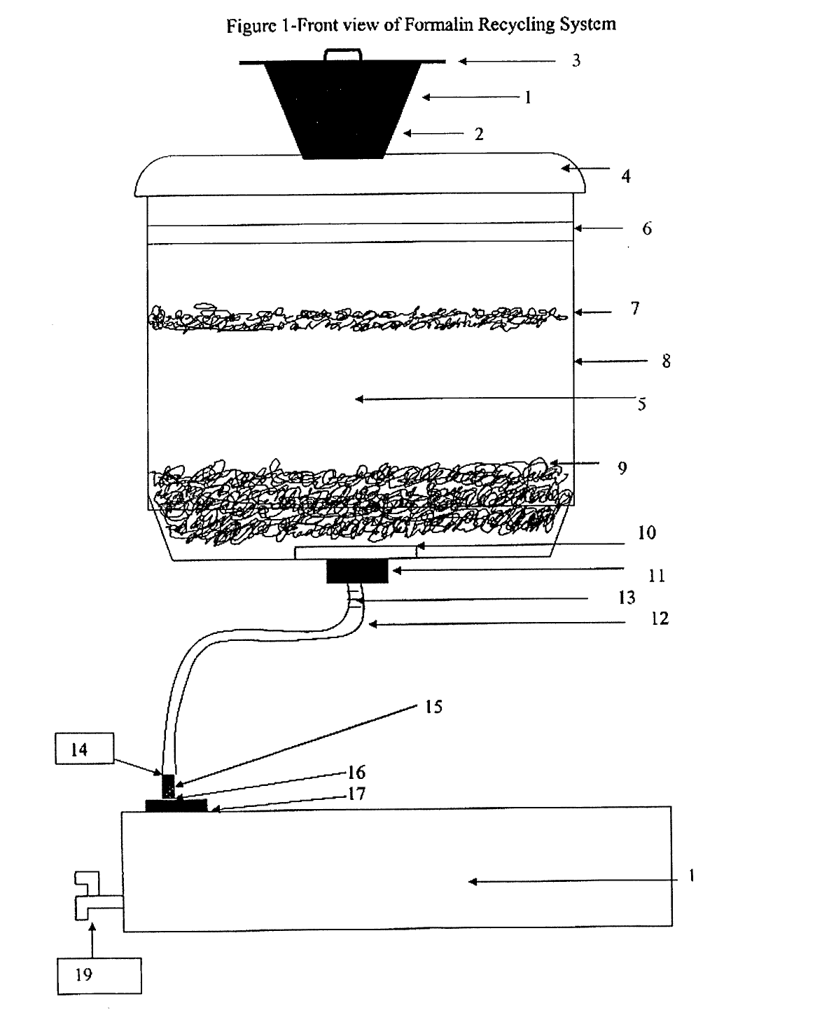

The Formalin Recycling System described herein can be used in a variety of formalin waste streams. Referring to FIG. 1 this preferred embodiment of the Formalin Recycling System contains the following items associated with it.

The invention allows for an inlet (funnel) at the top of the Formalin Recycling System 1. The funnel allows for the introduction of the formalin into the chamber. A pre-filter fiber and mesh screen 2 located in the funnel allows for the removal of larger type particles in the dirty formalin before it passes into the chamber 8. This funnel has a closable lid so that it can cover the funnel when not in use to further help in minimizing exposure to fumes 3.

The top lid to chamber in which the funnel is attached to is a removable lid 4. This allows for complete axis to the inside chamber so that the internal components may be manipulated when needed.

The chamber 8 serves several purposes. First, it holds the slurry 5 and components necessary to cleanup and recycle the dirty formalin. Secondly it acts as a holding chamber for the dirty formalin for best utilization of space and ease of use for the operator. A very important aspect to the design of the invention with respect to this chamber is that it allows for maximum residence time and filtration for the dirty formalin to pass through the slurry thus successfully cleaning it up prior to entering into the recycled formalin container/receptacle 18 for use again.

At the top of the inside of the chamber a diffuser 6 is placed. This diffuser is uniformly riveted with holes evenly placed through out it. Below the diffuser lays the filter fiber 7. The diffuser and filter fiber are an important aspect of the invention as they help to evenly disperse the dirty formalin through the slurry and also to help hold the slurry in place inside the chamber 8.

Below the diffuser and filter fiber lies the slurry 5 . The slurry cleans the particle containing dirty formalin into clean recycled reusable formalin again.

The slurry in the camber lays on a bed of filter fiber material located below the slurry 9. This bed of filter fiber material at the bottom of the camber lays on a second diffuser 10 located on top of the exit port 11 where the clean formalin exits into its recycling container/receptacle 18.

The top and bottom layers of diffusers 10 and filter fiber 9 material are an important part of the invention as these components hold the slurry in place so that the dirty formalin passes through it evenly and thoroughly. These two components also help hold the slurry in place when the Formalin Recycling System is moved to another location.

When the dirty formalin has passed through the slurry it exits at the bottom of the chamber through a tube 12 into the recycled formalin container/receptacle 18. This tube is attached to an opaque screw 13 which intern is screwed into the exit port at the bottom of the chamber. This tube has a shut off flow valve 14 at the end of it. This flow valve allows for the proper flow of formalin through the chamber and the slurry. If the dirty formalin runs through the slurry too fast it is not cleaned properly. If it runs to slow it will back the system up. The flow valve can also be shut off to stop the system from running at any time.

At the end of the shut off flow valve 14 a female shut-off quick connect 15 is located. This female shut-off quick connect 15 connects to a male shut off quick connect 16 located on the cap 17 at the top of the recycled formalin container/receptacle 18. These shut-off quick connects 15 and 16 allows for the operator to at any time stop the recycling process by simply disconnecting them.

The recycled formalin drains into a recycled formalin container/receptacle 18. This container/receptacle possess a spigot 19. The spigot 19 allows for easy filling of the recycled formalin into working container/receptacle.

Note: the cartridge consists of these items. The top lid 4, the slurry 5, the upper diffuser 6, upper filter fiber 7, the chamber 8, lower filter fiber 9, lower diffuser 10, outlet or exit port 11, and opaque screw 13.

What makes this invention new and unique is that this repeated process of cleaning the dirty formalin containing fats, lipids, anatomical-pathological tissue and cells and stains and dies runs solely by gravity. Once the formalin has collected into the recycled formalin container it can be assayed for validation of a working solution and reused again and again repeatedly.

Other unique features of the invention are as follows. Since the top lid of the chamber 4 can be removed it is a simple task to manipulate the top of the slurry 5 or change the inner components 6, 7, 8 and 9 if needed. The invention may be placed on a movable cart so that it can be wheeled from location to location at any time. The chamber 8 holding the slurry, fiber and diffusers can be recycled with new slurry, fiber and diffusers and be reused again saving the facility money and time. The system may also be placed horizontally into a counter or on a wall mount.

Moreover, while the invention has been explained with reference to a specific application, Formalin recycling, it can be implemented to work with other hazardous or non-hazardous fluids that contain particles and or stains and dyes such as alcohol and other solvents.

As can be appreciated from the disclosure provided above, the present invention has a wide variety of applications. Accordingly, the following is offered for illustration purposes and are not intended to be construed as a limitation on the invention in any way.

What is claimed is:

1. A filter cartridge for treating aqueous fluids containing fats and lipid membranes, the cartridge comprising an inlet, an outlet, a cartridge housing and filtration material where:
the cartridge housing comprises a side wall connected to a bottom end wall and an end wall with the walls forming a cartridge defining an inside portion;
the inlet is positioned proximal to or adjoining the upper end wall and the outlet is positioned proximal to or adjoining the bottom end wall;
the inside portion contains a top fluid diffuser, bottom fluid diffuser and filtration material wherein:
the top fluid diffuser is a multi-perforated wall laterally positioned with regard to the flow of the aqueous fluids and residing below the inlet and above the bottom fluid diffuser;
the bottom fluid diffuser is a multi-perforated wall positioned above the outlet, having a greater solid surface area than open surface area and capable of preventing the filtering material from passing through the outlet; and
the filtration material comprises fibrous and particulate filtering components where the fibrous filtering component is positioned between the inlet and the top fluid diffuser and above the bottom diffuser and below the particulate filtering component and where the particulate filtering component is positioned between the bottom fluid diffuser and top fluid diffuser.

2. A filter cartridge of claim 1 having a removable top.

3. A filter cartridge of claim 1 wherein the outlet is positioned on the end wall.

4. A filter cartridge of claim 1 wherein the outlet is positioned on the side wall.

5. A filter cartridge of claim 1 wherein the particulate component of the filtration material comprises charcoal.

6. A filter cartridge of claim 1 wherein the fibrous filtering component is selected from the group consisting of: cotton, glass wool, and polytetrafluroethylene.

7. A filter cartridge of claim 1 where the side walls and end walls form a cylinder.

8. A filter cartridge of claim 1 where the fluid contains formalin.

9. A filter cartridge of claim 1 where the inlet comprises a funnel shape containing a filter.

10. A filter cartridge of claim 1 where the top fluid diffuser is removable.

11. A method for purifying contaminated aqueous fluids comprising the step of passing fluid through a filter cartridge comprising an inlet, an outlet, a cartridge housing and filtration material where:
the cartridge housing comprises a side wall connected to a top end wall and an bottom end wall with the walls forming a cartridge defining an inside portion;
the inlet is positioned proximal to or adjoining the bottom end wall and the outlet is positioned proximal to or adjoining the top end wall;
the inside portion contains a top fluid diffuser, a bottom fluid diffuser and filtration material wherein:
the top fluid diffuser is a multi-perforated wall laterally positioned with regard to the flow of the aqueous fluids and residing below the inlet and above the bottom fluid diffuser;
the bottom fluid diffuser is a multi-perforated wall positioned above the outlet, having a greater solid surface area than open surface area and capable of preventing the filtering material from passing through the outlet; and
the filtration material comprises fibrous and particulate filtering components where the fibrous filtering component is positioned between the inlet and the top fluid diffuser and above the bottom diffuser and below the particulate filtering component and where the particulate filtering component is positioned between the bottom fluid diffuser and top fluid diffuser.

12. A method of claim of claim 11 wherein the aqueous fluid is formalin contaminated with cell membranes.

13. A method of claim 11 wherein the outlet of the cartridge is positioned on the end wall.

14. A method of claim 11 wherein the cartridge's inlet is positioned on the side wall.

15. A method of claim 11 wherein the filtration material comprises charcoal.

16. A method of claim 11 wherein the fibrous filtering component is selected from the group consisting of: cotton, glass wool, and polytetrafluoroethylene.

17. A method of claim 11 where the side walls and end walls form a cylinder.
